(19) United States
(12) Patent Application Publication
(10) Pub. No.: US 2005/0238213 A1
(43) Pub. Date: Oct. 27, 2005

(54) Half-portal access systems and methods

(76) Inventors: Joseph Randazza, Boca Raton, FL (US); Massimo Nais, Padova (IT)

Correspondence Address: PATTON BOGGS LLP, 8484 WESTPARK DRIVE, SUITE 900, MCLEAN, VA, 22102, US

(21) Appl. No.: 11/060,739

(22) Filed: Feb. 18, 2005

Related U.S. Application Data
(60) Provisional application No. 60/545,469, filed on Feb. 19, 2004.

(51) Int. Cl. G06K 9/00

(52) U.S. Cl. 382/124; 49/42; 340/5.53

(57) ABSTRACT

A system and method of securing an entryway is provided. The entryway includes a wall, a door frame, a door disposed therein, and a floor area. The system/method includes securing an access portal to the wall and to the floor area, the access portal having at least one door moveable from an open position to a closed position. The system/method further includes maintaining the at least one moveable door in a closed position based on at least one of: detection of more than one person in the cabin at a time; detection of contraband present in the cabin; or detection of a person in the cabin wearing a mask or disguise.

### FIELD OF THE INVENTION

The present invention is directed generally to entryways, and in at least some aspects, more specifically to a secure access entryway constructed for ease of installation, economy, and effective operation.

### BACKGROUND OF THE INVENTION

In the following discussion certain articles and methods will be described for background and introductory purposes. Nothing contained herein is to be construed as an “admission” of prior art. Applicant expressly reserves the right to demonstrate, where appropriate, that the articles and methods referenced herein do not constitute prior art under the applicable statutory provisions.

Historically, institutions requiring a relatively higher degree of security, such as banks, have relied on a number of measures of questionable effectiveness. Such institutions have typically permitted unrestricted ingress and egress, while focusing on security measures located inside the premises.

For example, banks have utilized closed-circuit television (CCTV) monitoring systems, security guards, and more recently, metal detectors. Such measures, however, have certain disadvantages. CCTV monitoring can be defeated by wearing a disguise. Security guards, especially when armed, can increase the possibility of violence since criminals anticipating a confrontation with an armed guard may be more prone to use deadly force, to the detriment of the safety of innocent bystanders and employees. Also, the cost of staffing a bank with a full-time security guard can be substantial. Metal detectors are prone to false alerts, and by themselves do nothing to stop an individual who triggers an alarm. Thus, metal detectors require labor-intensive staffing to stop people who set off the detector, and to keep people moving at a reasonable pace. Such devices can greatly impede ingress into a secure area.

Secure entrance systems have been developed that attempt to address the types of concerns described above. For example, U.S. Pat. No. 6,742,984 and U.S. patent application Publication No. US2003/0020607 describe a security entrance system that includes a structure defining an enclosed chamber. The structure includes the doors, a first set of moveable doors leading into the chamber, and a second set of moveable doors leading out of the chamber. The system includes a detector, such as a metal detector or a chemical detector. The system is said to further include a chamber monitoring system in the form of load cells that measure the weight of the contents of the chamber. The monitoring system is described as being capable of preventing more than one person at a time from entering, and then exiting, the chamber. This can be referred to as an anti-piggybacking or anti-tailgaiting system.

The above-described entrance system, however, has certain drawbacks. The size and physical construction of the system makes installation complicated, especially when the entrance system is to be used as a replacement for an existing doorway, etc. In such retrofit-type installations, typically the existing door must be removed, the doorway frame taken out and/or expanded, the surrounding wall structure modified and refinished, and the floor surface modified.

In addition to the above-described complex and costly installation, removal of the existing door of an entryway can result in a breach of pertinent fire code regulations. Access portals such as those described above often contain a significant amount of glass. Such structures are typically incapable of attaining a “fire-rated” door status. Thus, when a fire-rated door is required, its replacement by conventional access portals is often precluded.

The use of a metal detector as an access screening device can produce a large number of alerts, and the consequential denial of access. Frequent denial of access can discourage customers from patronizing the institution in which the system is installed. Such devices typically attain insufficient access rates in terms of the number of persons per hour, for example, some attain access rates on the order of 300 persons per hour.

In this type of entrance system, the use of weight measurement of the contents of the chamber as an anti-piggybacking device is an unreliable method of preventing more than one person at a time from exiting the chamber. This method relies on a minimum and maximum weight threshold for screening. A typical minimum weight threshold value is around 100lbs., and a typical maximum weight value is 285 lbs. The system denies entry if the weight measurement is below 100 lbs. or exceeds 285 lbs. It is evident that the combined weight of two people could easily be less than 285 lbs. For example, a 105 lb. woman could be forced to enter the chamber with a 165 lb. man, and still evade the weight-based anti-piggybacking detection system because their total weight would be 270 lbs.

Other techniques have been implemented to deter robbery/takeover scenarios. One such technique is biometrics, such as facial and retinal scans, etc. Another technique is ultrasonic scanning to detect piggybacking or tailgating situations, as well as the presence of contraband. An additional technique is to require a fingerprint scan prior to entry.

There is a need in the art for improvements in secure access systems.

### SUMMARY OF THE INVENTION

The present invention provides an access system configured such that it can be secured to a wall, the wall containing a door frame with an existing door disposed therein, the access system also configured such that it can be secured to an existing floor surface, the system comprising at least one access portal, the access portal comprising at least one component adapted to be fixed to the wall; at least one component adapted to be fixed to the floor; at least one stationary panel; at least one moveable door, wherein the access portal defines a cabin, the boundaries of the cabin being defined, at least in part, by the wall, the existing door, the at least one stationary panel, and the at least one moveable door.

The present invention also includes a method of securing an entryway, the entryway comprising a wall, a door frame, a door disposed therein, and a floor area, the method comprising the steps of: (i) securing an access portal to the wall and to the floor area, the access portal further comprising at least one door moveable from an open position to a closed position; (ii) maintaining the at least one moveable door in a closed position based on at least one of: detection of more than one person in the cabin at a time; detection of contraband present in the cabin; or detection of a person in the cabin wearing a mask or disguise.

### BRIEF DESCRIPTION OF THE DRAWINGS

The foregoing and other features, aspects and advantages of the present invention will become apparent from the following description, appended claims and the exemplary embodiments shown in the drawings, which are briefly described below. It should be noted that unless otherwise specified like elements have the same reference numbers.

FIG. 1 is a perspective view of the first embodiment of the present invention.

FIG. 2 is an exploded perspective view of the embodiment of FIG. 1.

FIG. 3 is a perspective view of certain aspects of an embodiment of the present invention.

FIG. 4 is a partial sectional view of selected floor-mounting features and components of an embodiment of the present invention.

FIG. 5 is a sectional top view of certain aspects and features of an embodiment of the present invention.

FIG. 6 is a detailed exploded view of various components of a system according to the present invention.

FIG. 7 is a sectional top view of various aspects of the present invention.

FIG. 8 is a sectional top view of various additional aspects of the present invention.

### DETAILED DESCRIPTION OF PREFERRED EMBODIMENTS

The principles of the present invention will now be further described by the following discussion of certain illustrative embodiments thereof, and by reference to the foregoing drawing figures.

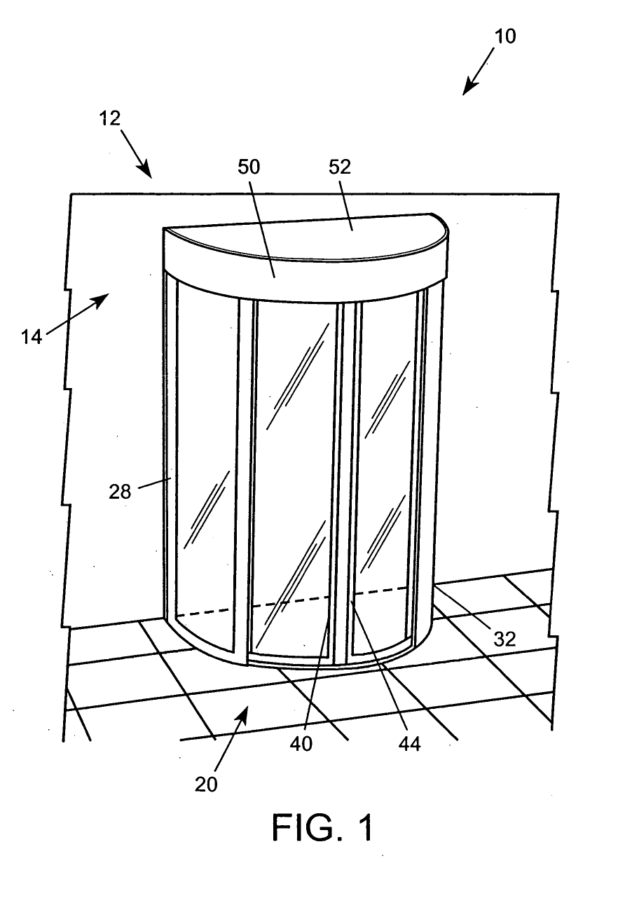

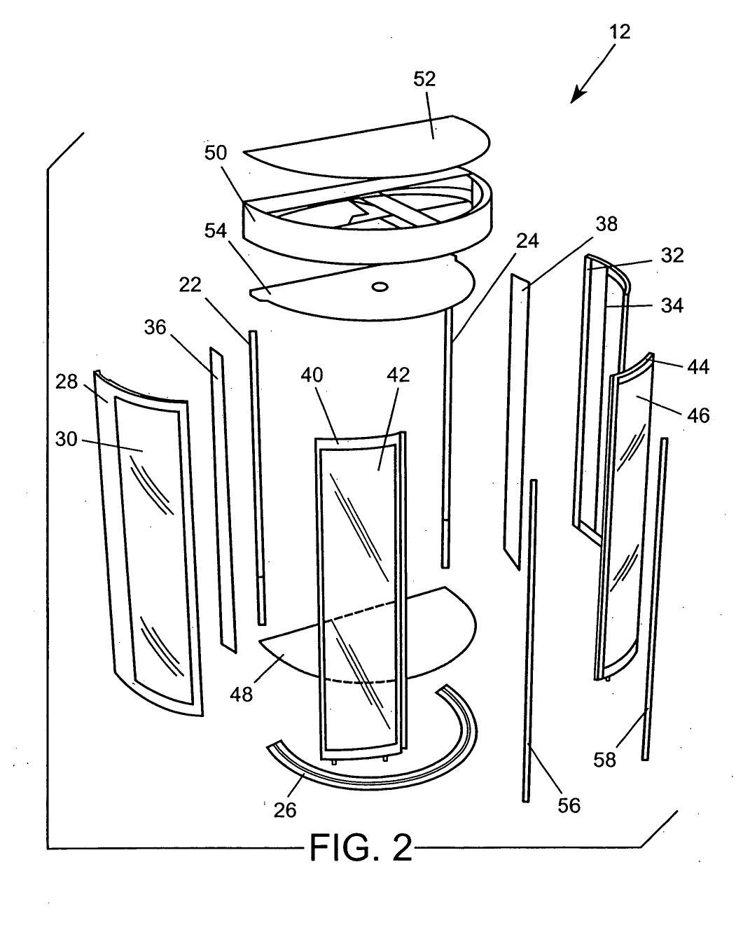

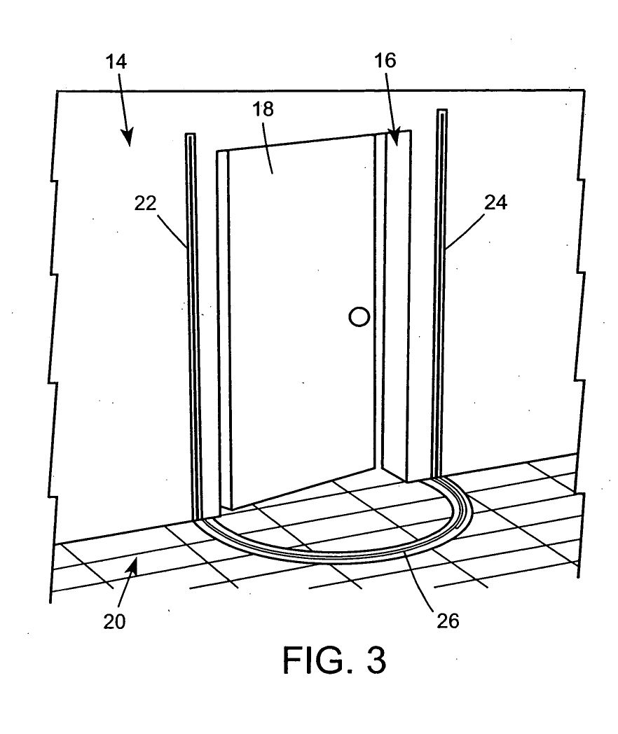

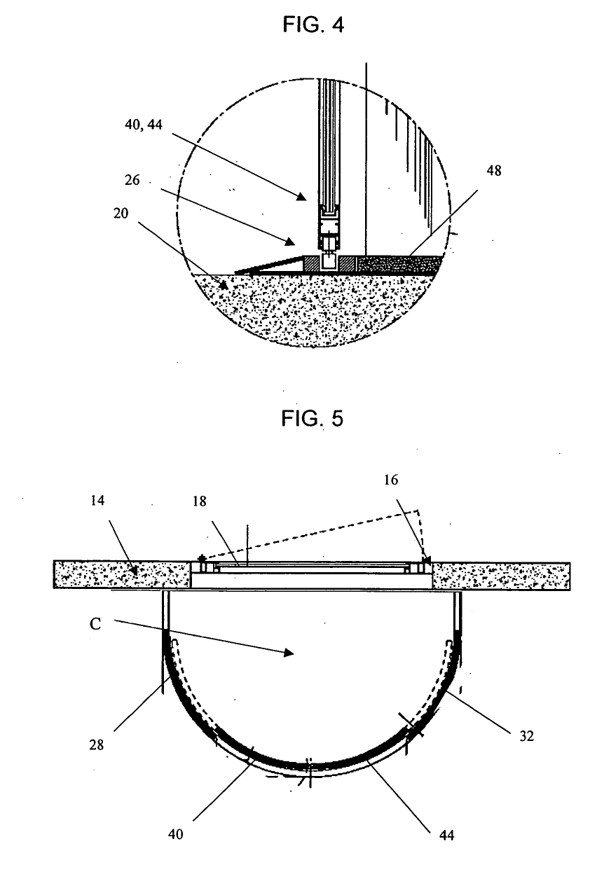

The access system shown generally by reference numeral 10 is configured according to the principles of the present invention is illustrated in FIGS. 1 through 5. The system 10 includes an access portal 12 and is configured such that it is capable of being installed, or retrofitted to an existing entryway. As illustrated, for example, in FIGS. 3, 4 and 5, the existing entryway generally comprises a wall 14 containing a doorframe 16 disposed therein. An existing door 18 is preferably mounted within the doorframe 16. The entryway also encompasses floor area 20.

It should be recognized that the access portal 12 of the present invention is also capable of being utilized in locations and entryways which differ from that of the above-referenced illustrated embodiment. In this regard, the existing door 18 may be removed. Alternatively, while the existing door 18 can be a simple flat hinged manually operated door, it can also comprise an automatically operated door, which is either of the hinged or sliding type. Moreover, the existing door 18 can also be in the form or a revolving door (not shown). The existing door can be reinforced or otherwise made more secure. Similarly, the wall 14, door frame 16 and floor area 20 can also possess configurations that differ from the illustrated embodiment.

According to one preferred aspect, regardless of the configuration of the existing entryway, the access portal 12 of the present invention can be retrofitted with either minimal, or no modification to the basic existing entryway construction. In this regard, the terminology “without substantial modification,” as used herein, is intended to encompass no modification to the existing entryway features as well as minimal modifications thereto. For example, with regard to existing walls, “without substantial modification” is intended to exclude significant removal and/or rearrangement of wall surface materials or structure wall components. With regard to existing floor surfaces, “without substantial modification” is intended to exclude significant removal and/or rearrangement of the existing floor surface materials or structural floor components, including the cutting of the floor. In any event, the terminology “without substantial modification” is intended to encompass drilling of the wall and/or floor of the existing entryway to attach fasteners thereto.

In the illustrated embodiment, the portal 12 is provided with a generally semi-circular shape. This shape is conveniently adapted for attachment to an existing entryway. It is within the scope of the present invention, however, to provide the portal 12 with a different shape, such as, a polygon or semi-ovular shape. As illustrated, for example, in FIG. 3, the access portal 12 is mounted to the existing wall 14 via at least one component adapted to be fixed to wall 14. This component may comprise a pair of wall attachment strips 22, 24. Similarly, the access portal 12 is attached to the existing floor 20 via at least one component adapted to be fixed to said floor 20. In the illustrated embodiment, this component comprises a semi-circular shaped floor mounted frame and door guide 26. It is within the scope of the present invention to alter the number and shape of the above-mentioned floor mounted components in accordance with the principles of the present invention, so long as the primary objective of attachment to an existing wall and/or floor surface without substantial modification thereto can be achieved. For example, as evident from the above embodiment, neither the wall surface nor the floor surface require modification, apart from any necessary drilling, to accommodate fasteners for securing the above-noted elements.

It is also within the scope of the present invention to integrate the access portal 12 into different environments. For example, instead of the illustrated entryway, the portal 12 can be used to secure the area surrounding an automated teller machine. In such an environment, the moveable doors provide controlled ingress, as well as egress, from the area surrounding the automated teller machine. The portal 12 may also be utilized in other environments, besides an existing entryway, such as to control access to safe-deposit boxes.

The access portal 12 may further include at least one stationary panel. In the illustrated embodiment, the access portal 12 comprises a first stationary panel 28, as well as a second stationary panel 32. The first and second stationary panels 28, 32 can be provided with a first stationary panel glass pane 30 and a second stationary glass pane 34, respectively. The glass panes 32 and 34 can comprise any suitable structural glass, such as vandal-resistant or bullet-resistant grade glass. For purposes of illustration, the glass can be provided with a thickness on the order of 10 mm-31 mm. It is within the scope of the present invention to provide stationary components which differ from that of the illustrated embodiment with respect to one or more of size, shape, composition and/or material.

The access portal 12 further optionally comprises a plurality of internal cover plates 36, 38, which facilitate mounting of the stationary panels, and serve to cover electronic and wiring which may be present within the panel 12.

Exit from the cabin C (FIG. 5) of access portal 12 is provided by at least one moveable door component. Movement of the at least one moveable door component is preferably automated, however, may also be selectively permitted via manual operation. According to the illustrated embodiment, a first moveable door 40 and a second moveable door 44 are provided such that, by moving toward and away from each other, they define an exit point with a selectively closed and open condition. Optionally, and according to the illustrated embodiment, the first and second moveable doors 40 and 44 include a first moveable door glass pane 42 and a second moveable door glass pane 46, respectively. The glass panes 42, 26 can be constructed as described above in connection with the glass panes optionally provided in the stationary panel components.

The at least one moveable door can be constructed and configured for the necessary movement according to techniques known to those of ordinary skill in the art. In the illustrated embodiment, the first and second moveable doors 40 and 44 are provided with rollers at their bottom and top sides which cooperate with tracks in the floor-mounted frame and door guide 26, as well as in the top frame member 50. Details of such constructions are known to those of ordinary skill in the art.

The interior of the access portal 12 optionally includes a floor mat 48 shaped and sized to fit within the inner periphery of the floor-mounted frame and door guide 26. Similarly, the access portal 12 can additionally be provided with a ceiling panel insert 54 sized and shaped to fit within the top frame 50. A suitable cover 52 may also be secured to the top frame 50. Preferably, at least one of the covers 52 and insert 54 are secured in such a manner so as to prevent escape from the cabin C therethrough. This feature represents an advantage over at least some comparable devices, in that many existing devices are constructed such that entire system can be defeated and circumvented by simply removing the top and climbing out this opening.

The access portal 12 can also optionally be provided with strips 56 and 58, which serve to conceal and/or protect wiring and electronic components which may be provided in the access portal 12.

According to one embodiment, the access portal is entered through an existing door or doorway, then exited through the moveable doors 40, 44. The doors 40, 44 can be opened via any suitable mechanism. For example, the doors can be configured to open automatically, triggered by a sensor that detects the presence of a person in the cabin. Alternatively, the doors 40, 44 can be opened by a push-button within the cabin, or may be manually opened via any suitable mechanical device. In this configuration, the access portal 12 functions essentially as an alternative to a revolving door. In this regard, the access portal 12 acts to maintain pressure and temperature conditions within the building, with the cabin C acting as a “buffer” between an existing exterior door and the interior of the building.

Alternatively, any type of access control device or system can be integrated with the access portal 12.

An anti-piggybacking or anti-tailgating device or system may be integrated with the access portal 12. According to one embodiment, this device or system comprises ultrasonic electrostatic transducers which, in cooperation with the appropriate hardware and software components, develops a sound wave-based profile of the contents of the cabin. This profile can be compared with a reference profile to determine whether one or two persons are located within the cabin C. This technique can also be used to scan the cabin after people have exited to determine if foreign objects have been left therein by comparing the sound profile of the cabin with a reference profile based on an empty cabin. Such systems can be readily assembled, acquired and/or integrated by those in the art. One illustrative system will now be described.

Once the system has detected that the previous occupant(s) of the cabin have exited, logic and control units activate a mass detector unit.

An exemplary system includes a mass detector unit which activates electroacoustic transducer cells under computerized or non-computerized control and logic on the part of a processing unit. The cells, individually or in groups, emit a pulse at ultrasonic frequency for a short time interval, usually a few tens of kilohertz, so that the waves propagate according to the radiation pattern of the transducers in a rather direct manner in order to have good resolution. An emitted wave train, which has an amplitude, propagates according to a wave cone that has a narrow angle until it encounters the surface that reflects it, generating an echo wave having an amplitude, which is picked up both by the transducer that emitted the wave and by other transducers or cells. The echo wave received by one or more cells is filtered in order to be recognized, then it reaches, through an amplifier unit, the processing unit, which analyzes it both in terms of the amplitude and in terms of the delay time with respect to the moment when it was emitted. If “d” is the distance between the transducer being considered and the surface of the affected booth, in the absence of foreign masses, then the delay time “t” is equal to “2d/v”, where “v” is the velocity of propagation of the wave inside the booth. The amplitude Ar of the received signal is equal to K.At.Sc, where K is a reflection coefficient and Sc is the extent of the surface that reflects the wave. In the absence of foreign masses, the delay times and the amplitudes of the reflected waves have values defined and stored in the processing unit.

In alternative constructions, a row of transducers, multiple strips, and/or reflectors are distributed on the ceiling of the cabin along parallel lines. The reflector(s) have mutually different heights so that the wave cone emitted by each transducer strikes all the reflector(s) and each one reflects toward the volume to be inspected. The reflected echo waves are conveyed toward the transducers. In this embodiment, when calculating the delay times and the attenuations of the received echo signals, the new paths of the transmitted waves and of the reflected waves are considered. In both of the above-described embodiments, in the presence of a foreign mass, regardless of where it is located within the inspected volume, the pulses reflected by said mass are different from the corresponding ones stored when the booth was empty of foreign masses, both in terms of the delay time parameter and in terms of the amplitude parameter. It is thus possible to determine, for each transducer cell, the distance of the incident foreign mass, and determine whether it is resting on the floor or suspended above it, while analysis of the amplitude of the echo wave allows to determine its nature, e.g., whether it is constituted by a body that is made of highly reflective material, such as a metal.

Cross-analysis of the time and amplitude parameters of the signals received by the cells or transducers allow for detection of the foreign objects, if present, their extent and position within the chamber and/or within the inspected volume, and the reflective characteristics of the sound waves from their surfaces, thus allowing an image to be generated from the processing of the data that can be displayed by a monitor. Accordingly, in the presence of one or more foreign objects whose dimensions are such that they can be configured as a weapon, the mass detector unit reports this to a logic processing unit, which can cause the doors of the cabin to remain closed. Finally, the unit can also activate an indicator which alerts the personnel inside the premises.

The electroacoustic transducers can operate at any suitable ultrasonic frequency, preferably with a frequency of a few tens of KHz. The transducers are distributed above the transit path of the cabin, or otherwise arranged so as to work in the transit path of the volume to be inspected. These transducers can be distributed and supported by a ceiling panel arranged in the ceiling of the transit path to be inspected.

An identity verification device or system can also be integrated with the access portal 12. Examples of such systems include biometric devices and systems such as facial or retinal scanners. Such devices and systems are readily available to those skilled in the art.

According to one embodiment, the access portal 12 incorporates a facial scanning system. A facial image of the occupant of the cabin is obtained, and the data contained in this image is compared and/or analyzed by appropriate hardware and software components. The criteria for permitting the occupant to exit the cabin and enter a secure area can vary. According to one alternative, the image of the occupant must match an image in a database of persons approved for entry. According to another embodiment, the image of the occupant is analyzed to determine whether the occupant of the cabin is wearing a mask or disguise. This embodiment is particularly effective as a deterrent and/or preventative technique to stop robbery in banks and other such institutions.

A fingerprint capture device and/or system may be integrated with the access portal 12. According to one embodiment, the occupant of the cabin is instructed to place one or more fingers in a position such that a fingerprint may be captured. The fingerprint is preferably captured as an electronic image. The fingerprint can optionally be analyzed by appropriate hardware and software components. The criteria for permitting the occupant to exit the cabin may vary. For example, exit from the cabin may be permitted when the fingerprint matches a database of the fingerprint data of a pool of persons authorized to enter a secure area. Alternatively, exit from the cabin may be denied if the fingerprint data taken from the occupant matches a database of fingerprint data of convicted criminals.

According to another embodiment, the fingerprint data of the occupant is simply stored in a memory device, without further analysis. In other words, the occupant is allowed to exit the cabin once it has been determined that a fingerprint has been successfully acquired. In the event of a robbery or other crime, this fingerprint data may be examined by law enforcement, and possibly used as evidence.

In order to address privacy concerns, and according to one embodiment of the invention, the biometric information such as facial images and/or fingerprint data is maintained for only a predetermined period of time, after which it is erased from memory. The access portal 12, or the surrounding area may include signage and/or audible information advising users of the access portal 12 of this practice in order to allay invasion of privacy concerns.

According to a further embodiment, the access portal 12 incorporates a metal detector. A positive alert triggered by the metal detector acts to deny exit from the cabin and entry into a secure area.

It is to be understood that it is within the scope of the present invention to integrate any of the above-mentioned access control devices and/or systems with the access portal. It is also within the scope of the present invention to incorporate combinations of some, or all, of the above-mentioned access control systems and/or devices into the access portal 12.

According to one embodiment of the present invention, regardless of the access control devices and/or systems utilized, the access portal is provided with a relatively high access rate. For example, according to an illustrative embodiment, the access portal of the present invention can achieve an access rate of at least 500 people per hour.

According to further embodiments, one or more safety features and/or mechanisms are included in the design of the access portal 12. For example, the access portal 12 may include a safety release that permits the moveable doors 40, 44 to open. This emergency release may be manually activated by a person located in the secure area. Alternatively, or in addition, the safety release may be in communication with a fire alarm system, so that upon activation of the fire alarm system, the safety release is automatically activated, thereby allowing exit from the cabin through the moveable doors 40, 44.

While various embodiments and illustrative configurations and methods of the present invention have been described, it should be understood that the present invention encompasses devices, systems, and methods that possess a combination of some, or all, of the following features: simple, low-cost installation without substantial modification of an existing entryway; the ability to be incorporated into an entryway while maintaining the fire-rating thereof; the flexibility to be configured as a non-secure entryway, e.g., essentially like a replacement for a revolving door, or as a secured robbery-deterring device; simple, economical manufacture; high access rates; highly effective ultrasonic transducer-based anti-piggybacking/anti-tailgating functionality; highly effective ultrasonic transducer-based volumetric scanning to detect contraband; a compact cabin to further deter piggybacking and tailgating; biometric-based anti-robbery functionality such as facial recognition and/or fingerprint capture techniques; a secure top to prevent escape and defeat of the system; measures to protect the privacy of the users of the device/system; and/or safety features permitting exit from the device/system in the event of an emergency.

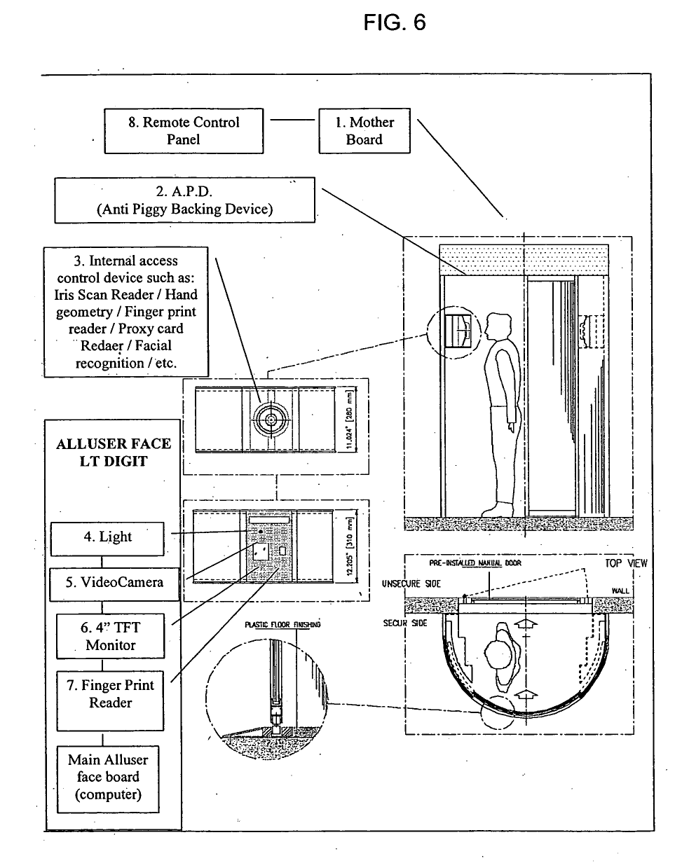

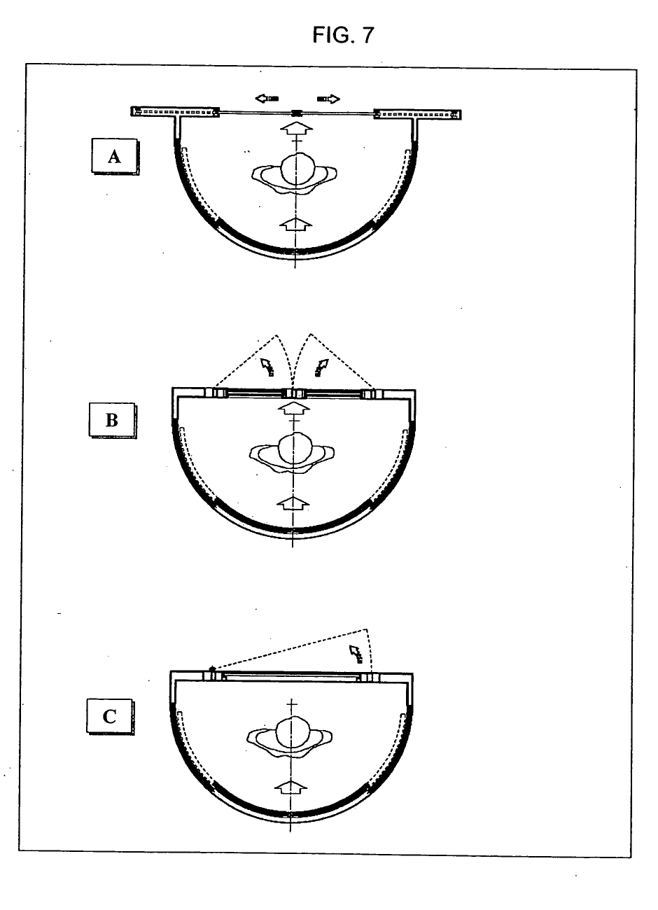

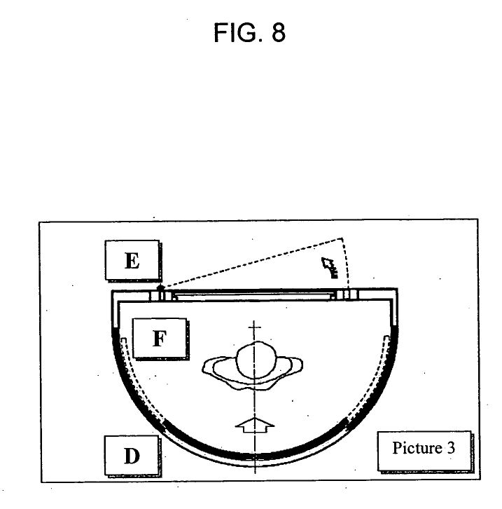

Various additional aspects and embodiments of the present invention can be gleaned from FIGS. 6-8; and the following supplemental description thereof.

System Details: Floor preparation: Flush mounted to a level surface. Floor pad cut not required. Cabin: Metal Structure available in different steel thicknesses: it is possible to install safety glasses, vandal resistant glasses, bullet proof glasses.

Emergency mechanical release level to unlock cabin's doors. It can be used only from secure side, and it is mounted on one side of the cabin.

Different cabin configuration: it can be mounted where there is an existing swing door (C), where there is an existing bi-parting swing door (B), or where there is an existing automatic sliding door system (C).

Cabin access protocol can be programmed through control panel (8) at anytime. It is possible in this way to change the purpose of the door depending from user requirement over the years, after the installation; These are some access protocol samples:

Standard entrance (Push button mode): (E) and (D) are push buttons. A user to walk through the cabin needs to push the button from the secure side or from unsecure side, than first door open, the person walk into the cabin, the first door closes and the second door opens only when the system check that the first one is closed.

Bank Mode: (E) and (D) are push buttons, (F) is alluser face LT digit system or a following alluser improved realese (see picture 1 and 3).

WAY IN: A user to walk through the cabin needs to push the button from the unsecure side, than first door opens, the person walk into the cabin, the first door closes; Alluser A.P.D. ultrasonic sensor (2) detect how many people are inside the cabin. A voice message invite the user to look his own image displayed into a monitor. Alluser face LT Digit check if inside the cabin there is a human face not disguised. If the system doesn't find an image which has enough details to be considered a human face, the first door opens and user is asked to leave the cabin and enter again. If the system alluser face Lt digit find enough details valid to recognize a human face, a picture of this face is made and store into database with date and time. Than another voice message invite user to leave an image of one of his finger print into the database by using finger print reader. If a clear image of fingerprint is properly stored, and If only one person is detected by A.P.D. (2), and if the first door is closed than the second door opens.

In case of a robbery, it is possible to download information such as a photograph and a finger print image of people where inside the bank at the robbery time.

This system can be set in the way that there only face image is captured, or only finger print image is captured, or both together.

Facial capturing system works with one or more video cameras, it depends from security level is required.

All images (faces, and fingerprints) are stored through a cryptographic system, in the way (in attendance to privacy law) nobody can get access to data a part from authorized people.

Access control mode (1^{st} sample): (E) and (D) are access control devices (such as proxy readers, badges, keypads, biometrics, etc.). A user to walk through the cabin needs to get a verification signal from access control located on the secure side or on the unsecure side, than first door opens, the person walk into the cabin, the first door closes; Alluser A.P.D. ultrasonic sensor (2) detect how many people are inside the cabin. If only one person is detected, and if the first door is closed than the second door opens.

An anti pass back system option can be enabled. If this function is enabled, after each passage through the cabin, and before a new one, the system has to detect that the cabin is with both doors locked, and with nobody inside.

Access control mode (2^{nd} sample): (E) and (D) and (F) are access control devices (such as proxy readers, badges, keypads, biometrics, etc.). A user to walk through the cabin needs to get a verification signal from access control located on the secure side or on the unsecure side, than first door open, the person walk into the cabin, the first door closes; User needs to be verified by the internal access control point. Alluser A.P.D. ultrasonic sensor (2) detect how many people are inside the cabin. If the internal access control point is ok and if only one person is detected, and if the first door is closed than the second door opens.

An anti pass back system option can be enabled. If this function is enabled, after each passage through the cabin, and before a new one, the system has to detect that the cabin is with both doors locked, and with nobody inside.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. It is intended that the scope of the invention be defined by the claims appended hereto, and their equivalents.

1. A secure access system configured such that it can be secured to a wall, the wall containing a door frame with an existing door disposed therein, the access system also configured such that it can be secured to an existing floor surface without substantial modification thereof, the system comprising:
at least one access portal, the access portal comprising:
at least one component adapted to be fixed to the wall;
at least one component adapted to be fixed to the floor;
at least one stationary panel; and
at least one moveable door,
wherein the access portal defines a cabin, the boundaries of the cabin being defined, at least in part, by the wall, the preexisting door, the at least one stationary panel, and the at least one moveable door.

2. The system of claim 1, wherein the existing door is hinged.

3. The system of claim 2, wherein the existing door is flat and manually opened.

4. The system of claim 1, wherein the existing door is automatically opened.

5. The system of claim 1, wherein the existing door is a revolving door.

6. The system of claim 1, wherein the at least one component adapted to be fixed to the wall comprises a plurality of wall attachment strips.

7. The system of claim 6, wherein the plurality of wall attachment strips comprise at least one strip disposed on the wall on either side of the existing door.

8. The system of claim 1, wherein the at least one stationary panel comprises a plurality of stationary sides, each side being attached, at least in part, to the at least one component adapted to be fixed to the floor.

9. The system of claim 1, wherein the stationary sides comprise glass panels.

10. The system of claim 1, wherein the at least one moveable door comprises a plurality of moveable door sections, each of which being attached, at least in part to the at least one component adapted to be fixed to the floor.

11. The system of claim 10, wherein the moveable door sections are constructed for movement away from each other to establish an open condition, and are moveable toward one another to establish a closed condition.

12. The system of claim 10, wherein each of the moveable door sections comprise at least one glass panel.

13. The system of claim 1, wherein the boundaries of the cabin define a generally semi-circular shape.

14. The system of claim 1, wherein the access portal further comprises at least one top frame member, and a top cover securely attached to the at least one top frame member.

15. The system of claim 14, wherein the at least one stationary panel and the at least one moveable door are attached, at least in part, to the at least one top frame member.

16. The system of claim 1, further comprising an ingress control system configured to control movement of the at least one moveable door between an open and closed condition.

17. The system of claim 16, wherein the ingress control system comprises at least one sensor for detecting the presence of more than one individual in the cabin.

18. The system of claim 17, wherein the at least one sensor comprises at least one ultrasonic electrostatic transducer.

19. The system of claim 1, further comprising an auxiliary power source, the auxiliary power source comprising at least one battery.

20. The system of claim 1, further comprising an emergency release mechanism for moving the at least one moveable door to an open position.

21. The system of claim 17, further comprising at least one sensor for determining whether contraband has been left inside the cabin.

22. The system of claim 17, further comprising a facial recognition system.

23. The system of claim 22, wherein the facial recognition system is configured to determine whether an individual in the cabin is wearing a mask or disguise.

24. The system of claim 22, further comprising a fingerprint capture device.

25. The system of claim 1, further comprising an intercom system.

26. A method of securing an entryway, the entryway comprising a wall, a door frame, a door disposed therein, and a floor area, the method comprising the steps of:
(i) securing an access portal to the wall and to the floor area without substantial modification thereof, the access portal further comprising at least one door moveable from an open position to a closed position;
(ii) maintaining the at least one moveable door in a closed position based on at least one of: detection of more than one person in the cabin at a time; detection of contraband present in the cabin; or detection of a person in the cabin wearing a mask or disguise.

27. The method of claim 26, wherein the access portal comprises boundaries defining a cabin, wherein the boundaries of the cabin define a semi-circular shape.

28. The method of claim 26, wherein step (ii) comprises performing a facial-recognition scan.

29. The method of claim 26, wherein step (ii) comprises scanning the cabin with at least one sensor comprising an ultrasonic electrostatic transducer.

30. The method of claim 26, further comprising the step of:
(iii) capturing the fingerprint of an individual in the cabin.
